(19) United States
(12) Patent Application Publication
(10) Pub. No.: US 2009/0134241 A1
(43) Pub. Date: May 28, 2009

(54) Painting machine

(75) Inventor: Andreas Hoffmann, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 12/313,839

(22) Filed: Nov. 25, 2008

(30) Foreign Application Priority Data
Nov. 28, 2007 (EP) 07023082.6

(51) Int. Cl. B05B 15/02

(52) U.S. Cl. 239/112

(57) ABSTRACT

A painting machine having a spray head for painting an object, a pump for conveying paint from a paint container via a feed line to the spray head and back via a return line to the paint container, the feed and return lines connected to a solvent container with a solvent for flush cleaning the painting machine. The feed and return lines are connected to a disposal container for disposing of paint and solvent residues, and at their respective container-side end to a first and second controllable multiway valve for switching the feed and return lines to the paint container, solvent container or disposal container. The painting machine has a control device for controlling the multiway valve such that execution of the consecutive operations of disposal of the paint, filling with solvent, flushing out the painting machine, disposing of the solvent, refilling with paint and also further conveyance of the paint are automated.

### CROSS REFERENCE TO RELATED APPLICATIONS

This application claims priority of European Patent Office application No. 07023082.6 EP filed Nov. 28, 2007, which is incorporated by reference herein in its entirety.

### FIELD OF INVENTION

The invention relates to a painting machine with at least one spray head for painting one or more objects and with a pump for conveying at least paint from a paint container via a feed line to the spray head and back via a return line to the paint container. For cleaning the painting machine, the feed line and the return line can be connected to a solvent container with a solvent.

### BACKGROUND OF INVENTION

These types of painting machine are used for example for painting components, housing parts, motor vehicles or printed circuit boards.

A method and also a system for cleaning a painting system are known from U.S. Pat. No. 7,156,112 B2. The cleaning system can be connected on the input side to a return line and on the output side to a feed line of the paint circuit for flush cleaning the painting circuit using a solvent. Alternately it can be connected on the input side to the feed line and on the output side to the return line.

A method for cleaning the flow channels of an automatically operating spray coating apparatus which can apply different coatings one after the other is known from German patent application DE 41 36 000 A1. In the method a pressure source for a solvent and a reservoir for a compressed gas are provided. The solvent and the compressed gas are fed simultaneously via control valves to a mixing valve. The mixture of solvent and gas is sent through the flow channels of the spray coating apparatus.

### SUMMARY OF INVENTION

To prevent the paint adhering to or hardening in the channels it is known that the paint is circulated in a circuit by means of a pump. The paint is sucked in such cases from a paint container and conveyed to one or more spray heads. At least a part of the non-sprayed paint is then conveyed back to the paint container again.

To maintain the desired quality of the painting process, such a painting machine must be flush cleaned at regular intervals in order to dispose of adhering paint residue as well as abraded material. Cleaning is also necessary if another paint type, such as a paint of another color for example, is to be used for painting. A cleaning system of the painting machine described at the start can be used for this purpose for example. However a disadvantageously large amount of solvent is required to clean a painting machine of this type. This is regrettable, given the increasing demands for environmental protection.

Using the prior art stated above as its starting point, an object of the invention is to specify an improved and more environmentally friendly painting machine.

The object of the invention is achieved with a painting machine with the features of the independent claim. Advantageous embodiments of the painting machine are given in the dependent claims.

The feed line and the return line can be connected to a disposal container for disposing of paint and solvent residues. The feed line and the return line are connected at their respective container-side end to a first and second controllable multiway valve for switching the feed line and the return line to the paint container, solvent container or disposal container. The painting machine has a control device for controlling the multiway valves such that in the operations of disposal of the paint, filling with solvent, flush cleaning of the painting machine, disposal of the solvent, refilling with paint as well as conveying of the paint can be undertaken consecutively in an automated manner.

The great advantage is that, by comparison with the prior art, the amount of solvent is greatly reduced, by paint residues as well as the first mixed products of paint and solvent being conveyed out of the painting machine into the disposal container at the beginning of the cleaning phase.

A further advantage is that, by comparison with the prior art, no compressed air source to drive a separate circulation pump for the solvent is needed.

According to one embodiment the first multiway valve has three valve inlets, with one valve inlet being connected to the paint container, the solvent container or to a gaseous medium respectively. The gaseous medium is especially ambient air. The second multiway valve has three valve outlets, with one valve outlet being connected to the paint container, solvent container or disposal container respectively. The important factor is that three possible paths from the three valve outlets to the common feed line as well as three possible paths from the common return line to the valve outlets can be set. This type of multiway valve can be one unit. Alternatively, by series connection and/or through parallel connection of conventional valves it can be implemented with a single inlet and outlet.

According to a further embodiment the at least one spray head has a cut-off valve connected upstream from it which when actuated allows the passage of paint to the spray head. In other words the object is only painted when the cut-off valve is controlled by the control device. Preferably the cut-off valve is accommodated as close as possible to the spray head in order to enable all pipes and hoses of the painting machine to be cleaned. For cleaning of the remaining short pipe and hose sections from the cut-off valve to the spray head the cut-off valve can be briefly activated. Furthermore a cut-off valve is preferably connected upstream from each spray head. Alternatively just one cut-off valve can be connected upstream from all spray heads or some of the spray heads.

In accordance with a further embodiment the respective controllable multiway valve has at least one further valve inlet or valve outlet which is connected to a further paint container in each case. The control device is embodied such that refilling with paint as well as conveyance of the paint can be undertaken optionally from one of the connected paint containers. This enables different paint types, especially different paint colors, to be used.

Preferably a filter unit is present in the feed line and/or in the return line. It is used for filtering the circulating paint in the painting machine. Filtered substances collecting therein, such as solid paint residues or abrasion materials, can be emptied out via a drain valve. If the drain valve, in accordance with a further embodiment, is a drain valve able to be controlled by means of the control device, then the filtered substances, if the drain valve is connected to the disposal container, can be disposed of during the disposal of the paint and/or of the solvent into the disposal container.

According to a preferred embodiment the valves are able to be operated by compressed air. Connected upstream from the respective valves is a compressed air valve which can be controlled electrically in each case by the control device and which is connected via a compressed air line to the respective valve. The compressed air activation prevents a possible deflagration or explosion of the usually combustible solvent.

According to one embodiment a fill level indicator is present in at least one of the connected containers. The respective fill level indicator has a signaling or data connection to the control device. This enables a warning message to be output by means of the control device if the paint and especially the solvent are running out. A further warning message can be output if the disposal container reaches an upper fill level, i.e. if the disposal container is full. If necessary further emptying of the painting machine can then be stopped by means of the control device.

According to a further embodiment a viscosity measuring unit is present in the inlet or return line for detecting the viscosity of the spray fluid. The viscosity measuring unit has a signaling or data connection to the control device. This advantageously makes possible ongoing checking of the circulating paint in respect of the desired viscosity of the paint within a permitted range. The viscosity measuring unit can be a Stabinger viscosimeter for example.

Finally, according to an advantageous embodiment, an optical sensor for detecting the optical characteristics of the paint and/or of the solvent is present in the inlet or return line. The optical sensor has a signaling or data connection to the control device. An optical characteristic can for example be the opacity or the color. This enables the opacity, meaning the purity or clarity of the solvent, to be determined during the cleaning. Thus, after the paint has been disposed of during the cleaning phase, the increasing clarity of the solvent subsequently supplied and mixing with the solvent is detected. If the solvent then reaches a specified clarity value, the disposal of the solvent into the disposal container is stopped and in the circulating cleaning phase is skipped.

### BRIEF DESCRIPTION OF THE DRAWINGS

The invention as well as advantageous embodiments of the invention will be described in greater detail below on the basis of the subsequent figures.

FIG. 1 shows a typical structure of a painting machine and

FIG. 2 shows a typical execution scheme of a cleaning cycle.

### DETAILED DESCRIPTION OF INVENTION

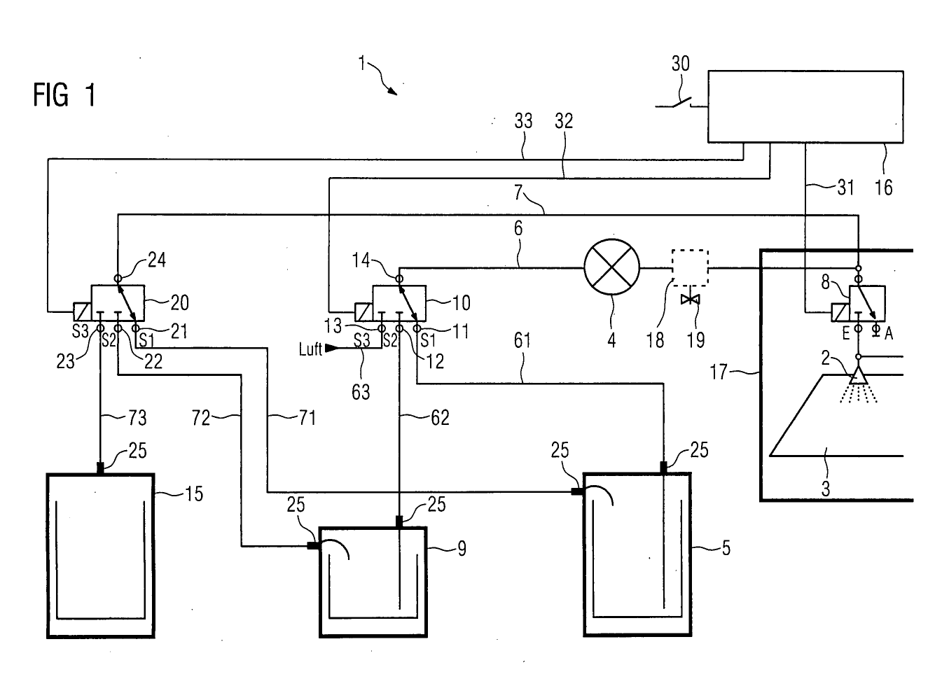

FIG. 1 shows the typical structure of a painting machine 1. The right hand part of FIG. 1 shows a section of a spray cabin 17. Typically only one spray head 2 for painting an object 3 is arranged in the spray cabin. It can be moved by means of a movement mechanism not shown in further detail for painting the object 3. The object 3 for example can be a printed circuit board which is provided in this way with protective paint. The spray head 2 is connected on its input side to a feed line 6. A pump 5 for conveying at least the paint is provided in the feed line 6. The pump 4 is connected on its input side to a paint container 5 from which the paint is sucked in. On the output side the spray head 2 is connected to a return line 7 for return of the paint not sprayed. Via this line the paint is conveyed back to the paint container 5.

Shown in the lower part of FIG. 1 is the paint container 5, a solvent container 15 as well as a disposal container 15 for disposing of paint and solvent residues. The feed line 6 and the return line 7 are able to be connected or are connected to the disposal container 15. The feed line 6 and the return line 7 are connected at their respective container-side end to a first and second controllable multiway valve 10, 20 for switching the feed line 6 and the return line 7 to the paint container, solvent container or disposal container 5, 9, 15. The reference symbol 16 refers to a control device 16 which is embodied for activation of the multiway valves 10, 20 such that the operations of disposal of the paint, filling with solvent, flush cleaning of the painting machine, disposal of the solvent, refilling with paint and also onwards conveyance of the paint are able to be carried out consecutively in an automated manner. The control device 16 shown is especially a Programmable Logic Controller (PLC). Alternately it can be a PC or industrial computer. The control device 16 itself can be arranged on the painting machine 1. It can alternately be arranged remotely from the painting machine, such as via an Intranet for example. A software program for activation of the multiway valves 10, 20 in the previously described chronological sequence is able to be executed on the control device 16.

The first multiway valve 10 shown in the central part of FIG. 1 has three valve inlets 11-13. The first valve inlet 11 is connected to the paint container 5. The second valve inlet 12 is connected to the solvent container 9. The third valve inlet 13 is not connected, i.e. it is open. Connecting lines in the form of pipes or hoses are labeled with reference symbols 61-63. Connecting lines to the containers 5, 9, 15 are labeled with the reference symbol 25. The arrow depicted in the multiway valve 10 shows the idle position of the multiway valve 10, if this is not activated via a control line 32 of the control device 16. In this switching position S1 paint flows out of the paint container 5 through the first multiway valve 10 to the common valve connection 14 in the feed line 6. In a second switching position S2 preferably solvent flows in the feed line 6 and in a third switching position S3 outside air can be sucked into the feed line 6.

The second multiway valve 20 depicted in the left-hand part of FIG. 1 features three valve outlets 21-23. The first valve outlet 21 is connected to the paint container 5. The second valve outlet 22 is connected to the solvent container 9. The third valve outlet 23 is connected to the disposal container 15. Once again connecting lines in the form of pipes or hoses are labeled with the reference symbols 71-73. The arrow depicted in the second multiway valve 20 shows the idle position, if the valve is not activated via a further control line 33 by the control device 16. In this switching position S1 paint typically flows out of the return line 7 via a common valve connection 24 back into the paint container 5. In the second switching position S2 solvent preferably flows back to the solvent container 9. In the third switching position S3 paint and/or solvent residues preferably flow into the disposal container 15.

In the example of FIG. 1 the control device 16 has a switching means 30, especially a pushbutton to start the cleaning of the painting machine 1. Furthermore an optional filter unit 18 indicated by a dashed line in the figure is present in the feed line 6. The filtered substances collected in the filter unit 18 can be emptied out via a drain valve 19. The drain valve 19, which is not shown in the diagram, can be connected to the disposal container 15. If the drain valve 19 is a controllable drain valve, the filtered substances can likewise be disposed of via the control device 16 during the disposal of the paint and/or of the solvent into the disposal container 15.

In the example in FIG. 1 a cut-off valve 8 is also connected upstream from the spray head 2. Depending on the valve position E, A (on, off) this allows passage of the paint to the spray head 2.

In addition the respective controllable multiway valve 10, 20 can feature at least one further valve inlet or valve outlet which is connected in each case to a further paint container. In this case the control device 16 is embodied such that refilling with paint as well onward conveyance of the paint can optionally be carried out from one of the connected paint containers. In this case by corresponding programming or activation of the control device 16 different paint types or paint colors can be selected for painting the object 3. For reasons of clarity only one paint container 5 is shown in FIG. 1.

In the example of FIG. 1 the valves 8, 10, 19, 20 are controlled via electrical signals of the control device 16. As an alternative the valves 8, 10, 19, 20 can be valves actuatable by compressed air, upstream from each of which is connected an electrically-controllable compressed air valve. The compressed air valves, which then for their part activate the valves 8, 10, 19, 20 via compressed air, can be electrically activated by means of the control device 16. In the example of FIG. 1 the compressed air valves are also not shown for reasons of clarity, nor are the level indicators which may be arranged in or on the containers 5, 9, 15 or in the inlet or return line 6, 7 or viscosity measurement units present in a paint container 5 for detecting the viscosity of the paint. The figure likewise does not show optical sensors for detecting the optical characteristics of the paint and/or of the solvent. The corresponding sensor signals can likewise by detected by the control device 16 and taken into account for the process.

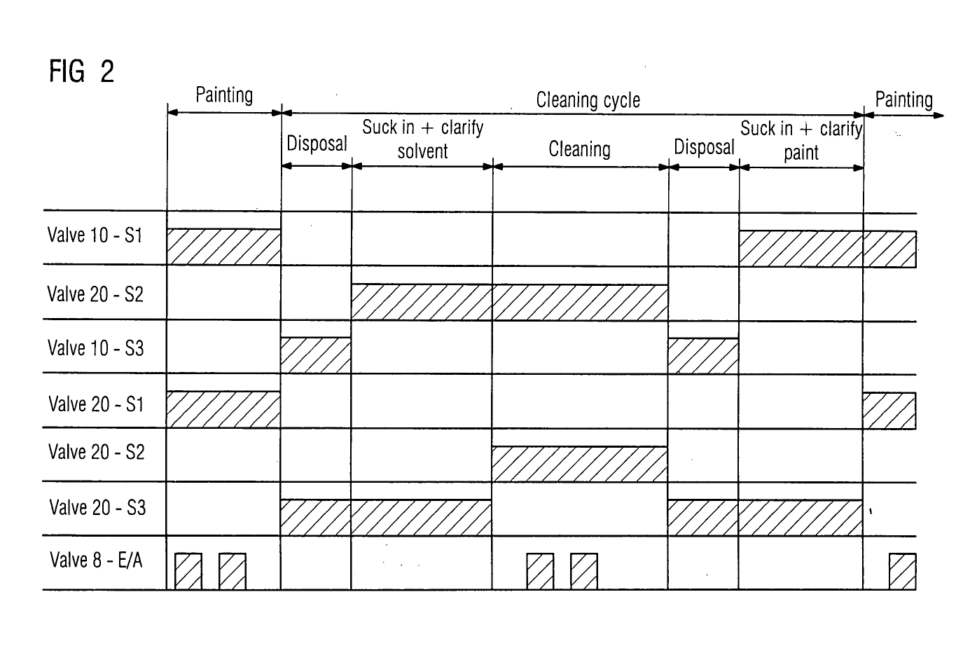

FIG. 2 shows a typical execution scheme of a cleaning cycle. The column in the left-hand part of FIG. 2 shows the switching position S1-S3 of the first and second multiway valve 10, 20 as well as the on and off position E, A of the cut-off valve 8 at the spray head 2 of the painting machine 1. The chronological steps of the cleaning cycle are depicted from left to right, beginning after an operational painting step “painting”. After the end of the cleaning cycle an operational painting step “painting” starts once again. Active switching positions S1-S3, E, A are depicted as cross-hatched blocks.

In the “painting” step the two multiway valves 10, 20 are in switching position S1. In this case paint is conveyed out of the paint container 5 to the spray head 2. During the switch-on times of the cut-off valve 8 the paint is sprayed and in the switch-off times returned via the second multiway valve 20 into the paint container 5.

In the subsequent step “disposal” the two multiway valves 10, 20 are in the switching position S3. The paint present in the painting machine 1 is drained via the second multiway valve 20 by means of the pump 4 into the disposal container 15 while simultaneously outside air is sucked via the first multiway valve 10 for refilling the emptied paint.

In the next step “sucking in+clarifying solvent” the first multiway valve 10 switches from switching position S3 into switching position S2. In this case solvent is sucked in by means of the pump 4 via the first multiway valve 10, which first flushes out the feed line 6 and then the return line 7 and in doing so increasingly “contaminates” said lines. At the end of the return line 7 the contaminated solvent is drained off into the disposal container 15. This step can be timed. Preferably an optical sensor of the control device 16 signals that a predetermined degree of cleanliness of clarity is the typically transparent solvent is reached.

If this is the case, the second multiway valve 20 likewise switches in the step “cleaning” into the switching position S2. The solvent now present in the painting machine 1 circulates and over time dissolves paint residues which have adhered to the pipes, hoses and armatures during the course of painting. In the step “cleaning” the cut-off valve 8 can be briefly activated in order to clean out paint residues in the line section from cut-off valve 8 to spray head 2.

Preferably after a predetermined cleaning time the two multiway valves 10, 20 switch in the step “disposal” into the switching position S3. The solvent present in the painting machine 1 is drained via the second multiway valve 20 by means of pump 4 into the disposal container 15, while simultaneously outside air is sucked back in via the first multiway valve 10.

In the next step “suction+clarify paint” the first multiway valve 10 switches from the switching position S3 into the switching position S1. In this case new paint is sucked in by means of the pump 4 via the first multiway valve 10 which first flows in through the feed line 6 and then through the return line 7. The first part of the new paint conveyed through the line is further thinned by solvent and is not suitable for spraying, i.e. for painting. This part is drained off at the end of the return line 7 into the disposal container 15. This step can be timed. Preferably an optical sensor of the control device 16 signals that a predetermined color saturation value has been achieved as an optical characteristic.

If a number of paint containers are present and if the multiway valve 10, 20 has further inputs and outputs as well as further switching positions for sucking in and returning the further paint, a corresponding color sensor is required. By comparing the characteristic optical data of the paint used with the correspondingly detected color values and color saturation values a signal can be created which shows that the desired paint quality has been reached. The comparison can e.g. be undertaken by means of a suitable software routine of the control device 16.

With the switchover of the multiway valve 10, 20 into the switching position S0 the end of the cleaning cycle is reached.

1.-10. (canceled)

11. A painting machine, comprising:
a spray head for painting at least one object;
a paint container having paint;
a pump for conveying paint from the paint container via a feed line to the spray head and back via a return line to the paint container;
a solvent container with a solvent for cleaning the painting machine, the feed line and the return line connected to the solvent container;
a disposal container, the feed line and the return line connected to the disposal container for disposing of paint and solvent residues;
a first and second controllable multiway valve, the feed line and the return line at their respective container-side end connected to the first and second controllable multiway valve for switching the feed line and the return line to the paint container, solvent container or disposal container; and
a control device for controlling the multiway valves such that the execution of consecutive operations of disposal of the paint, filling with solvent, flushing out of the painting machine, disposal of the solvent, refilling with paint and also conveyance of the paint are automated.

12. The painting machine as claimed in claim 11, wherein the first multiway valve has three valve inlets with a respective valve inlet connected to the paint container, to the solvent container or to a gaseous medium, and wherein the second multiway valve has three valve outlets with a respective valve outlet connected to the paint container, the solvent container or the disposal container.

13. The painting machine as claimed in claim 11, further comprising:
a cut-off valve connected upstream from the spray head, which allows passage of the paint to the spray head or not depending on the valve position

14. The painting machine as claimed in claim 12, further comprising:
a cut-off valve connected upstream from the spray head, which allows passage of the paint to the spray head or not depending on the valve position

15. The painting machine as claimed in claim 11, wherein the respective controllable multiway valve features at least one further valve inlet or outlet, which is connected in each case to a further paint container and wherein the control device is embodied such that a refilling with paint as well as a further conveyance of the paint is taken optionally from one of the connected paint containers.

16. The painting machine as claimed in claim 12, wherein the respective controllable multiway valve features at least one further valve inlet or outlet, which is connected in each case to a further paint container and wherein the control device is embodied such that a refilling with paint as well as a further conveyance of the paint is taken optionally from one of the connected paint containers.

17. The painting machine as claimed in claim 11, further comprising:
a filter unit arranged in the feed line or in the return line; and
a drain valve, wherein the filtered substances collected in the filter unit are emptied out via the drain valve.

18. The painting machine as claimed in claim 11, further comprising:
a filter unit arranged in the feed line and in the return line; and
a drain valve, wherein the filtered substances collected in the filter unit are emptied out via the drain valve.

19. The painting machine as claimed in claim 17, further comprising:
a controllable drain valve connected to the disposal container and controlled by the control device during the disposal of the paint or of the solvent for disposing of the filtered substances.

20. The painting machine as claimed in claim 17, further comprising:
a controllable drain valve connected to the disposal container and controlled by the control device during the disposal of the paint and of the solvent for disposing of the filtered substances.

21. The painting machine as claimed in claim 11, wherein the multiway valves, the cut-off valve and the drain valve are actuated by compressed air and that each valve has a compressed air valve connected upstream of the valve, the compressed air valves controlled electrically by the control device and connected via a compressed air line to the respective valve.

22. The painting machine as claimed in claim 11, further comprising:
a level indicator arranged in the paint container, the solvent container or the disposal container, wherein the level indicator has a signaling or data connection to the control device.

23. The painting machine as claimed in claim 12, further comprising:
a level indicator arranged in the paint container, the solvent container or the disposal container, wherein the level indicator has a signaling or data connection to the control device.

24. The painting machine as claimed in claim 15, further comprising:
a level indicator arranged in the paint container, the solvent container or the disposal container, wherein the level indicator has a signaling or data connection to the control device.

25. The painting machine as claimed in claim 11, further comprising:
a viscosity measurement unit for detecting viscosity of spray fluid in the feed line or the return line, wherein the viscosity measurement unit has a signaling connection or data connection to the control device.

26. The painting machine as claimed in claim 22, further comprising:
a viscosity measurement unit for detecting viscosity of spray fluid in the feed line or the return line, wherein the viscosity measurement unit has a signaling connection or data connection to the control device.

27. The painting machine as claimed in claim 11, further comprising:
an optical sensor for detecting optical characteristics of the paint and/or of the solvent arranged in the feed line or the return line, wherein the optical sensor has a signaling connection or data connection to the control device.

28. The painting machine as claimed in claim 26, further comprising:
an optical sensor for detecting optical characteristics of the paint and/or of the solvent arranged in the feed line or the return line, wherein the optical sensor has a signaling connection or data connection to the control device.
